(19) United States
(12) Patent Application Publication
(10) Pub. No.: US 2007/0286448 A1
(43) Pub. Date: Dec. 13, 2007

(54) Electroacoustic transducer diaphragm

(75) Inventor: Masatoshi Sato, Yamagata (JP)

Correspondence Address: ARENT FOX LLP, 1050 CONNECTICUT AVENUE, N.W., SUITE 400, WASHINGTON, DC, 20036, US

(73) Assignees: Pioneer Corporation; Tohoku Pioneer Corporation

(21) Appl. No.: 11/802,780

(22) Filed: May 24, 2007

(30) Foreign Application Priority Data
May 25, 2006 (JP) 2006-145192

(51) Int. Cl. H04R 13/00

(52) U.S. Cl. 381/424

(57) ABSTRACT

An electroacoustic transducer diaphragm is a multi-layered one which includes an intermediate diaphragm layer formed between a first surface layer and a second surface layer. The first and second surface layers are formed of a woven fabric and are formed in one piece with the fiber axial orientations of the first and second surface layers being shifted by a specified angle. Preferably, the first and second surface layers made of a biaxial woven fabric are formed with their fiber axial orientations being shifted by about 45 degrees. Thus, the multi-layered electroacoustic transducer diaphragm having surface diaphragm layers formed of the woven fabric is provided in order to reduce deformation and distortion, thereby producing a high-quality multi-layered diaphragm.

### BACKGROUND OF THE INVENTION

The present invention relates to an electroacoustic transducer diaphragm.

The present application claims priority from Japanese Patent Application No. 2006-145192, the disclosure of which is incorporated herein by reference.

Physical properties required in a method for manufacturing a diaphragm used with electroacoustic transducers such as speakers or microphones are a high specific modulus (E/ρ), high specific flexural rigidity (E/ρ3), moderate internal loss, high resistance to mechanical fatigue, and high weather resistance. Well-known diaphragms are formed of, for example, paper, cloth, a polymeric material, or metal. It has been suggested that those diaphragms be formed in a multi-layered structure of a plurality of raw materials having different physical properties in order to complement drawbacks of individual materials, thereby providing a diaphragm with various characteristics balanced.

For example, a method for manufacturing a multi-layered diaphragm used with electroacoustic transducers is disclosed in Japanese Patent Laid-Open Publication No. 2000-4496. According to this method, surface diaphragm layers are formed in advance in a predetermined size and shape, then the surface diaphragm layers are inserted into an injection mold, and thereafter, an injection material is injected into the injection mold, thereby providing a diaphragm molded in one piece which has the surface diaphragm layers and an inner diaphragm layer.

For example, suppose that first and second surface diaphragm layers (skin layers) of a woven fabric are inserted into an injection mold, and then an injection material or a material for forming an intermediate layer (core layer) is injected in between the first and second surface diaphragm layers, thereby preparing a diaphragm 1J in which the first and second surface diaphragm layers 31J and 32J and the intermediate layer 5 are formed in one piece as shown in FIG. 1A. In this case, the resin layer (the intermediate layer) formed by injection molding has a comparatively high shrinkage due to shrinkage caused by the molding. On the other hand, the first and second surface diaphragm layers (skin layers) of the woven fabric are resistant to shrinkage because they are made up of woven cloth. Thus, after the diaphragm is taken out of the mold, it may be deformed due to internal stress of the diaphragm.

In more detail, for example, as shown in FIG. 1B, a skin layer of a woven fabric has orientations in which it easily stretches and hardly stretches or orientations in which it easily bends and hardly bends. More specifically, as shown in FIG. 1B, the surface diaphragm layer 31J (32J) of the woven fabric tends to readily stretch diagonally (at an angle of 45 degrees) relative to the fiber axial orientation of the woven fabric and readily contract in an orientation orthogonal thereto. Thus, for example, as shown in FIG. 1C, it may be deformed diagonally relative to the fiber axial orientation. The woven fabric also tends to be easily crimped along a diagonal axis (at an angle of 45 degrees). The deformed diaphragm employed as a diaphragm for loudspeakers may cause deterioration in the quality of reproduced sound.

### SUMMARY OF THE INVENTION

The present invention was developed in view of the aforementioned problems. It is therefore an object of the present invention to provide a multi-layered electroacoustic transducer diaphragm, having a surface diaphragm layer formed of a woven fabric, which is reduced in deformation. It is another object of the invention to provide a high-quality multi-layered diaphragm.

To achieve these objects, the present invention is configured at least according to the independent claim set forth below.

One aspect of the present invention is a multi-layered electroacoustic transducer diaphragm having an intermediate diaphragm layer formed between a first surface diaphragm layer and a second surface diaphragm layer. The electroacoustic transducer diaphragm is characterized in that the first surface diaphragm layer and the second surface diaphragm layer are formed of a woven fabric, and are formed in one piece with the first surface diaphragm layer and the second surface diaphragm layer having their fiber axial orientations shifted by a specified angle.

Preferably, the first surface diaphragm layer is formed of a first biaxial woven fabric, and the second surface diaphragm layer is formed of a second biaxial woven fabric having the fiber axial orientation shifted by the specified angle relative to the first woven fabric. With the first surface diaphragm layer and the second surface diaphragm layer being inserted in an injection mold, an injection material serving as a material for forming the intermediate diaphragm layer is injected in between the first surface diaphragm layer and the second surface diaphragm layer, so that the first surface diaphragm layer, the intermediate diaphragm layer, and the second surface diaphragm layer are formed in one piece.

Additionally, the electroacoustic transducer diaphragm is characterized in that the first surface diaphragm layer and the second surface diaphragm layer are preferably formed to have their fiber axial orientations shifted by approximately 45 degrees.

The aforementioned electroacoustic transducer diaphragm is configured such that the first surface diaphragm layer and the second surface diaphragm layer are formed of a woven fabric, and the first surface diaphragm layer and the second surface diaphragm layer are disposed to have their fiber axial orientations shifted by a specified angle, for example, by about 45 degrees when a biaxial woven fabric is employed as the first and second surface diaphragm layers. Additionally, the first surface diaphragm, the intermediate diaphragm layer, and the second surface diaphragm layer are formed in one piece. Thus, the first and second surface diaphragm layers have their respective orientations of deformation shifted by the specified angle, thereby allowing the electroacoustic transducer diaphragm to be reduced in distortion, deformation or the like. It is also possible to provide a high-quality multi-layered diaphragm which is reduced in distortion.

### BRIEF DESCRIPTION OF THE DRAWINGS

These and other objects and advantages of the present invention will become clear from the following description with reference to the accompanying drawings, wherein:

FIG. 1A is a cross-sectional view illustrating a typical three-layered electroacoustic transducer diaphragm, FIG. 1B being an explanatory view illustrating the orientation of deformation of surface layers 31J and 32J, and FIG. 1C being an explanatory view illustrating the surface layers 31J and 32J after having been deformed;

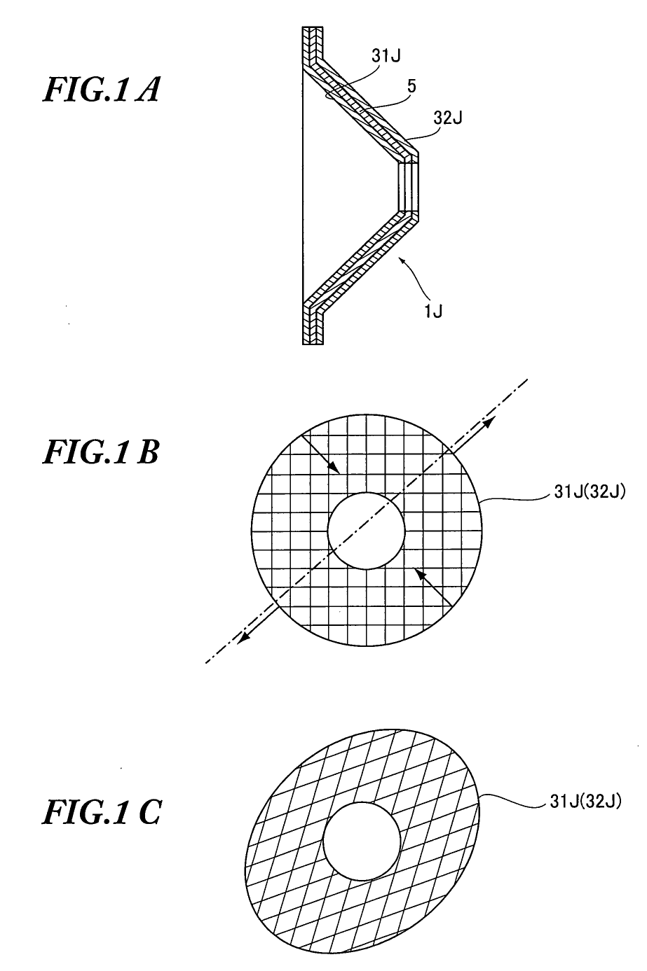

FIGS. 2A to 2D are explanatory views illustrating an electroacoustic transducer diaphragm 1 according to an embodiment of the present invention, FIG. 2A being a cross-sectional view illustrating the electroacoustic transducer diaphragm 1, FIG. 2B being an explanatory view illustrating a surface layer 3 (first surface layer 31) of the electroacoustic transducer diaphragm 1 shown in FIG. 2A, FIG. 2C being an explanatory view illustrating a surface layer (second surface layer 32) of the electroacoustic transducer diaphragm 1 shown in FIG. 2A, and FIG. 2D being an explanatory view illustrating a shift in the fiber axial orientation of the surface layer 3 shown in FIGS. 2B and 2C;

FIG. 3 is an explanatory view illustrating the fiber axial orientation of the woven fabric of the surface layers 31 and 32 shown in FIGS. 2A to 2D;

FIG. 4 is an explanatory block diagram illustrating an injection molding machine to be used in, a method for manufacturing an electroacoustic transducer diaphragm 1 according to an embodiment of the present invention;

FIGS. 5A to 5F are explanatory views illustrating a method for manufacturing an electroacoustic transducer diaphragm 1 according to an embodiment of the present invention;

FIGS. 6A to 6C are explanatory views illustrating an injection foaming step in a method for manufacturing an electroacoustic transducer diaphragm 1; and

FIG. 7 is an explanatory sectional view illustrating the injection foaming step shown in FIGS. 6A to 6C.

### DETAILED DESCRIPTION OF THE PREFERRED EMBODIMENTS

A description will now be given regarding the embodiment of the present invention with reference to the drawings.

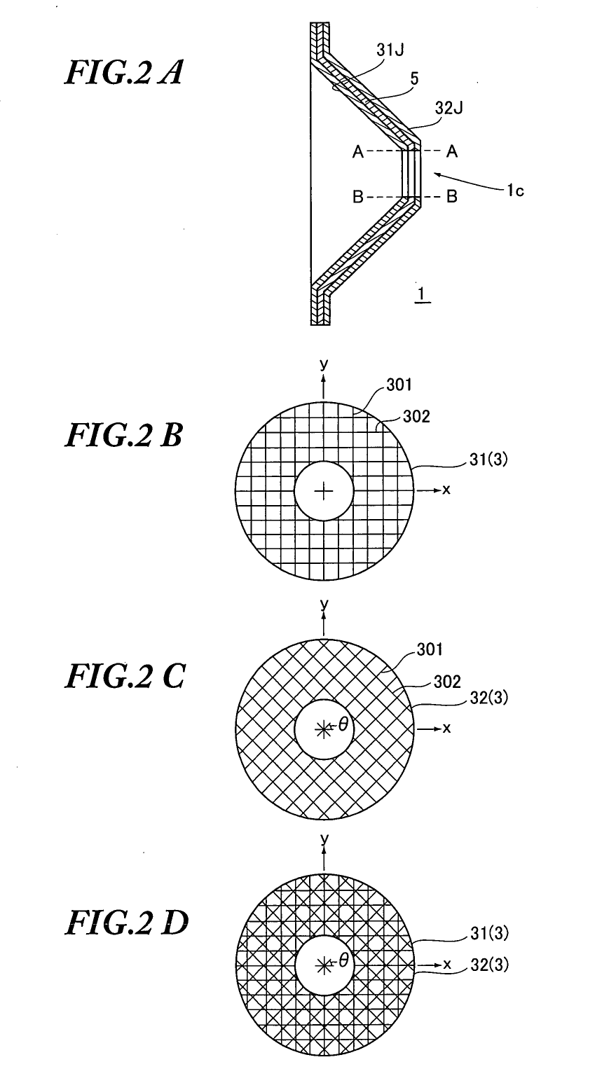

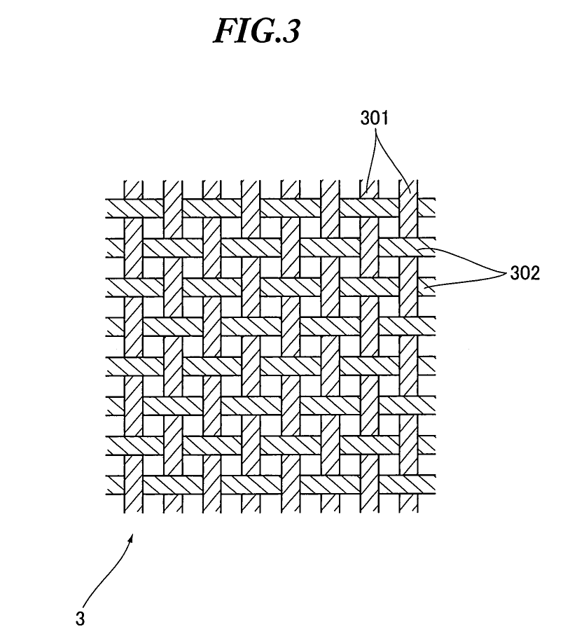

FIGS. 2A to 2D are explanatory views illustrating an electroacoustic transducer diaphragm 1 according to the embodiment of the present invention. In more detail, FIG. 2A is a cross-sectional view illustrating the electroacoustic transducer diaphragm 1. FIG. 2B is an explanatory view illustrating a surface layer 3 (first surface layer 31) of the electroacoustic transducer diaphragm 1 shown in FIG. 2A. FIG. 2C is an explanatory view illustrating a surface layer (second surface layer 32) of the electroacoustic transducer diaphragm 1 shown in FIG. 2A. FIG. 2D is an explanatory view illustrating a shift in the fiber axial orientation of the surface layer 3 shown in FIGS. 2B and 2C. FIG. 3 is an explanatory view illustrating the fiber axial orientation of the woven fabric of the surface layers 31 and 32 shown in FIGS. 2A to 2D.

Now, by way of example, a description will be made to the electroacoustic transducer diaphragm 1 which is conical in shape; however, the embodiments of the present invention are not limited thereto, and can also be directed to an electroacoustic transducer diaphragm having a variety of shapes, such as dome-shaped, planar, or flat-shaped diaphragm. A conical electroacoustic transducer diaphragm is not also limited to the following structure. Furthermore, although a description will be made to the electroacoustic transducer diaphragm 1 which is circular in shape; however, the invention is not limited thereto. The electroacoustic transducer diaphragm 1 may be formed in any other shapes, for example, an elliptical or rectangular shape. The electroacoustic transducer diaphragm 1 according to the present invention can be employed, for example, as a diaphragm for an electroacoustic transducer such as loudspeakers.

As shown in FIGS. 2A to 2D, the electroacoustic transducer diaphragm 1 according to this embodiment is constructed in a multi-layered structure which has an intermediate diaphragm layer 5 (hereinafter also referred to as a core layer 5) formed between the first surface diaphragm layer 31 (hereinafter also referred to as the surface layer 31) and the second surface diaphragm layer 32 (hereinafter also referred to as the surface layer 32). Hereinafter, the surface layer 31 and the surface layer 32 may also be referred to collectively as the surface layer 3. The surface layer 31 and the surface layer 32 are formed of a biaxial woven fabric such that the surface layer 31 and the surface layer 32 have their fiber axial orientations shifted by a specified angle θ. The surface layer 31, the intermediate diaphragm layer 5, and the surface layer 32 are formed in one piece. Although the electroacoustic transducer diaphragm 1 according to this embodiment is constructed in a three-layered structure; however, the present invention is not limited thereto. For example, the electroacoustic transducer diaphragm 1 may also be constructed in any other multi-layered structures having more than three layers.

The surface layer 31 corresponds to one embodiment of the first surface diaphragm layer according to the present invention, the surface layer 32 corresponds to one embodiment of the second surface diaphragm layer according to the present invention, and the intermediate diaphragm layer 5 corresponds to one embodiment of the intermediate diaphragm layer according to the present invention.

The surface layer 31 and the surface layer 32 of various types of well-known fibers such as resin, aramid fiber, or carbon fiber are formed in a specified diaphragm shape such as in a conical, dome, planar, or flat shape by a predetermined biaxial weave (such as plain weave or twill weave). Additionally, as shown in FIG. 2B, FIG. 2C, and FIG. 3, the surface layer 31 and the surface layer 32 according to this embodiment are formed by a biaxial weave in a manner such that a warp 301 and a weft 302 are woven to be generally orthogonal to each other. The axial direction of the fiber of the warp 301 and the weft 302 corresponds to one embodiment of the fiber axial orientation according to the present invention. The fiber axial orientation corresponds to an orientation of the mesh.

Furthermore, the electroacoustic transducer diaphragm 1 is manufactured such that the surface layer 31 formed of a first biaxial woven fabric and the surface layer 32 formed of a second biaxial woven fabric having a fiber axial orientation shifted by a specified angle, for example, by an angle of about 45 degrees relative to the surface layer 31 are inserted into an injection mold. Under this condition, an injection material or a material for forming the intermediate diaphragm layer is injected in between the surface layer 31 and the surface layer 32. The surface layer 31, the intermediate diaphragm layer 5, and the surface layer 32 are thus formed in one piece.

The intermediate diaphragm layer (core layer) 5, which is formed of a material different from that of the surface layers 31 and 32, is stacked in intimate contact with the surface layers 31 and 32. Additionally, as described later, the intermediate diaphragm layer 5 is formed by injecting the injection material into the injection mold. Those materials used as the injection material for the intermediate diaphragm layer 5 can include a specified material, for example, a mixture of a base material, such as an olefin-based resin like a polypropylene resin, and a foaming agent with an inorganic or organic filler.

Additionally, for example, as shown in FIG. 2A, the electroacoustic transducer diaphragm 1 has an opening portion 1c which is formed by cutting out its central portion in a tubular shape along lines A-A and B-B. For example, this opening portion 1c is used to accommodate the voice coil bobbin of a loudspeaker device.

As described later, the electroacoustic transducer diaphragm 1 constructed as described above is manufactured such that the surface layer 31 and the surface layer 32 are inserted into an injection mold, and under this condition, an injection material or a material for forming the intermediate diaphragm layer 5 is injected in between the surface layer 31 and the surface layer 32. Thus, the surface layer 31, the intermediate diaphragm layer 5, and the surface layer 32 are formed in one piece (injection molding). Here, the surface layer 31 is formed of a first biaxial woven fabric, and the surface layer 32 is formed of a second biaxial woven fabric having a fiber axial orientation shifted by a specified angle relative to the first woven fabric.

The electroacoustic transducer diaphragm 1 constructed as described above is adapted such that the intermediate diaphragm layer 5 (resin layer) formed by injection molding has a high shrinkage due to shrinkage caused by the molding. In particular, the intermediate diaphragm layer 5 has a comparatively high shrinkage when the intermediate diaphragm layer 5 is formed of an olefin-based resin or by foaming. On the other hand, the surface layers 31 and 32 made up of a woven fabric is apt to stretch diagonally (at an angle of 45 degrees) relative to the fiber axial orientation of the woven fabrics and contract in an orientation orthogonal thereto. As shown in FIGS. 2A to 2D, the electroacoustic transducer diaphragm 1 according to this embodiment is constructed such that the surface layer 31 and the surface layer 32 have their fiber axial orientations shifted by a specified angle, and the surface layers 31 and 32 and the intermediate diaphragm layer 5 are formed in one piece. Accordingly, the surface layers 31 and 32 have their respective orientations (deformable orientations), in which they are readily deformed, shifted by a specified angle, thereby allowing the electroacoustic transducer diaphragm 1 to be reduced in distortion, deformation and the like. This also makes it possible to provide a high-quality multi-layered electroacoustic transducer diaphragm 1 which is reduced in distortion. It is also possible to deliver high-quality sound by employing the electroacoustic transducer diaphragm 1 according to the present invention for loudspeaker devices.

In particular, even when the intermediate diaphragm layer 5 is formed of an olefin-based resin or the intermediate diaphragm layer 5 is formed by foaming, it is also possible to provide the electroacoustic transducer diaphragm 1 which has a relatively little distortion or small deformation.

In the aforementioned embodiment, the angle of shift in the fiber axial orientation of the surface layers 31 and 32 is set as appropriate according to the reproduction environment and the frequency characteristic of the loudspeaker device so long as the electroacoustic transducer diaphragm 1 can be reduced in distortion and deformation. Furthermore, the angle of shift in the fiber axial orientation of the surface layers 31 and 32 is set, for example, generally at 45 degrees, more strictly at about 45+/−15 degrees, or most strictly at 45 degrees.

With reference to the drawings, a description will now be given regarding a method for manufacturing the electroacoustic transducer diaphragm 1 to be constructed as described above.

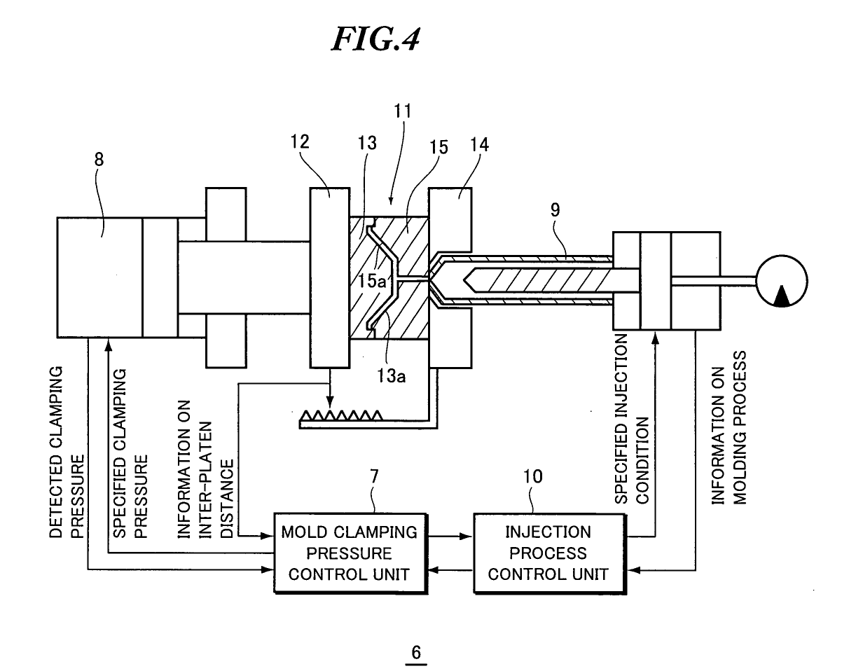

FIG. 4 is an explanatory block diagram illustrating an injection molding machine used for a method for manufacturing the electroacoustic transducer diaphragm 1 according to one embodiment of the present invention. As shown in FIG. 4, an injection molding machine 6 according to this embodiment includes a mold clamping pressure control unit 7, a mold clamping cylinder 8, an injector 9, an injection process control unit 10, injection molding dies (an injection mold) 11, a movable platen 12, a male die 13, a stationary platen 14, and a female die 15.

The injection molding machine 6 is used to manufacture the electroacoustic transducer diaphragm 1 according to this embodiment. The mold clamping pressure control unit 7 receives from the mold clamping cylinder 8 a signal indicative of the detected value of the clamping pressure for the injection mold 11, and also receives, for example, from the movable platen 12, a signal indicative of information on the distance between the movable platen 12 and the stationary platen 14. The mold clamping pressure control unit 7 outputs to the mold clamping cylinder 8 a signal indicative of the clamping pressure specified based on these signals in order to control the mold clamping cylinder 8 and thereby control the clamping pressure to be applied to the male die 13 and the female die 15. The mold clamping cylinder 8 detects the clamping pressure between the male die 13 and the female die 15, and then outputs the resulting signal to the mold clamping pressure control unit 7. Additionally, upon reception of the signal indicative of the specified clamping pressure from the mold clamping pressure control unit 7, the mold clamping cylinder 8 adjusts the clamping pressure to be applied to the male die 13 and the female die 15 via the movable platen 12 in accordance with the signal.

The injector 9 outputs a signal indicative of information on the molding process to the injection process control unit 10. Additionally, the injector 9 receives a signal indicative of a specified injection condition from the injection process control unit 10, and then performs the specified injection process in accordance with the signal. The injector 9 according to this embodiment injects a resin mixture of a base material, such as an olefin-based resin like PP (polypropylene), and a foaming agent with an inorganic or organic filler. The injection process control unit 10 receives a signal indicative of the information on the molding process from the injector 9, and also receives a signal indicative of distance information of the movable platen 12 side or the like from the mold clamping pressure control unit 7. Then, the injection process control unit 10 outputs a signal indicative of an injection condition specified based on these signals to the injector 9. Additionally, the injection process control unit 10 and the mold clamping pressure control unit 7 exchange data with each other to collectively control the entire injection molding machine 6.

The injection mold 11 is used to manufacture the electroacoustic transducer diaphragm 1. As shown in FIG. 4, the injection mold 11 includes, for example, the male die 13 and the female die 15. In this embodiment, the male die 13 is held by the movable platen 12 to act as a movable die, whereas the female die 15 is held by the stationary platen 14 to act as a stationary die. The male die 13 has a conical projected portion 13a formed along the contour of the surface of the electroacoustic transducer diaphragm 1. The male die 13 is located in position relative to the female die 15, thereby forming a gap in a specified shape related to the second diaphragm layer 5. The female die 15 has a conical recessed portion 15a formed corresponding to the conical projected portion 13a.

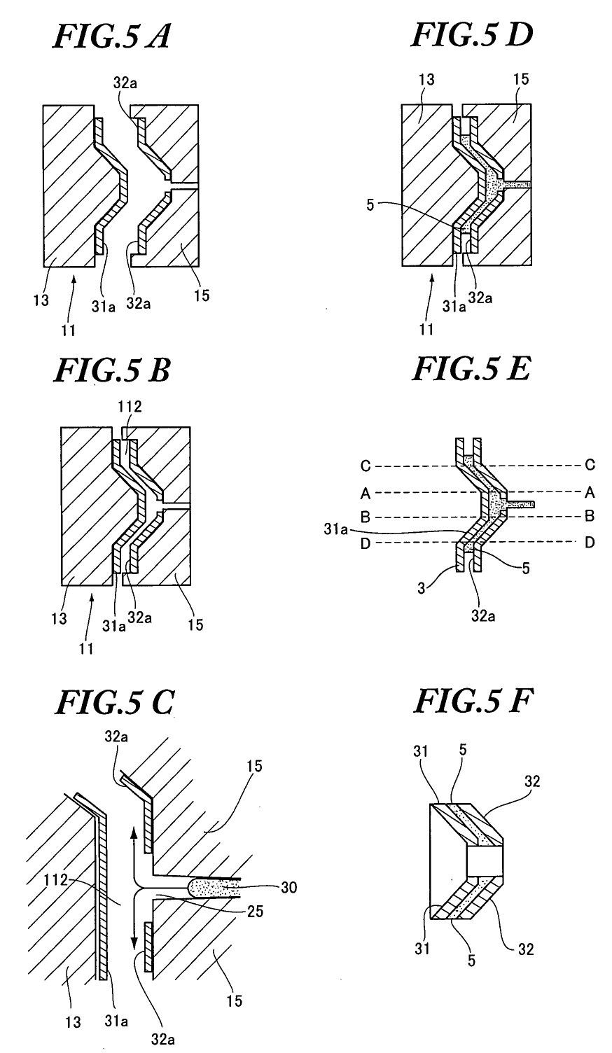

FIGS. 5A to 5F are explanatory views illustrating a method for manufacturing the electroacoustic transducer diaphragm 1 according to an embodiment of the present invention. With reference to FIGS. 5A to 5F, a description will now be given regarding a method for manufacturing the electroacoustic transducer diaphragm 1 using the injection molding machine 6 according to one embodiment.

To begin with, as shown in FIG. 5A, the mold clamping pressure control unit 7 provides control to the mold clamping cylinder 8 such that the male die 13 and the female die 15 of the injection mold 1 are spaced apart from each other by a predetermined separation. A biaxial woven fabric 31a or the surface layer 31 prepared in a specified shape is attached to the male die 13, while a biaxial woven fabric 32a or the surface layer 32 prepared in a specified shape is also attached to the female die 15. Upon this attachment (insertion), the biaxial woven fabric 31a and the biaxial woven fabric 32a are inserted into the injection mold 11 such that the biaxial woven fabric 32a has a fiber axial orientation shifted by a specified angle (by about 45 degrees) relative to the woven fabric 31a. At this stage, the woven fabrics 31a and 32a may be fixed onto the respective dies 13 and 15 by a vacuum suction device.

Thereafter, as shown in FIG. 5B, the mold clamping pressure control unit 7 provides control to the mold clamping cylinder 8 such that the injection mold 11 is closed for the male and female dies 13 and 15 to be spaced apart from each other by a specified space. At this stage, a gap 112 is formed in a predetermined diaphragm shape in between the male and female dies 13 and 15.

As shown in FIG. 5C, the injection process control unit 10 provides control to the injector 9 such that an injection material 30 or a material for forming the intermediate diaphragm layer 5 is injected through an injection gate 25. The injection material 30 flows into the gap 112 defined between the male die 13 and the female die 15.

As shown in FIG. 5D, the injection process control unit 10 provides control for the injector 9 to inject a specified amount of the injection material 30 and then prevents the injection so that the injection material 30 is formed in a specified shape between the woven fabric 31a and the woven fabric 32a. Alternatively, for example, the injection molding may also have an additional step in which the male die 13 and the female die 15 which are in the closed position are moved away from each other by a predetermined amount during the injection to allow the resin to easily flow therebetween and then brought into the closed position again during the injection.

As shown in FIG. 5E, after the injection molding is ended, the mold clamping pressure control unit 7 provides control to the mold clamping cylinder 8 such that the male die 13 and the female die 15 of the injection mold 11 are moved away from each other by a predetermined amount into an open position. The injection molded diaphragm is taken out of the injection mold 11 which is in the open position. Then, as shown in FIG. 5E, the resulting diaphragm is cut out in a tubular shape at the central portion along lines A-A and B-B. Additionally, the outer circumferential portion of the electroacoustic transducer diaphragm 1 is cut off along lines C-C and D-D.

As shown in FIG. 5F and FIG. 2A, through the aforementioned manufacturing steps, a multi-layered electroacoustic transducer diaphragm 1 can be prepared in which the surface layer 31, the intermediate diaphragm layer 5, and the surface layer 32 are formed in one piece, with the surface layer 32 having a fiber axial orientation shifted by about 45 degrees relative to the surface layer 31.

As described above, the surface layer 31 of the biaxial woven fabric 31a and the surface layer 32 of the biaxial woven fabric 32a having a fiber axial orientation shifted by a specified angle (about 45 degrees) relative to the woven fabric 31a are inserted into the injection mold 11. Under this condition, the injection material 30 or the material for forming the intermediate diaphragm layer 5 is injected in between the surface layer 31 and the surface layer 32 to mold the surface layer 31, the intermediate diaphragm layer 5, and the surface layer 32 in one piece. These simple manufacturing steps make it possible to prepare the electroacoustic transducer diaphragm 1 constructed as described above according to the present invention.

Alternatively, for example, in the aforementioned method for manufacturing the electroacoustic transducer diaphragm 1, the woven fabric 31a and the woven fabric 32a may be cut away from a comparatively large woven fabric and used for the surface layer 31 and the surface layer 32, thereby allowing the woven fabrics 31a and 32a to be prepared with improved efficiency, for example, when compared with the case of preparing them individually. The woven fabrics 31a and 32a used for the surface layers 31 and 32 come from the same woven fabric, and are thus equal to each other in properties such as rigidity, the orientation of distortion, and the magnitude of distortion, there by making it possible to provide a high-quality electroacoustic transducer diaphragm 1. It is also possible to reduce variations in the quality of the electroacoustic transducer diaphragm 1.

Furthermore, employing the surface layer 31 and the surface layer 32 which are generally equal to each other in rigidity makes it also possible to prepare a high-quality electroacoustic transducer diaphragm 1.

A description will now be given regarding a method for manufacturing the electroacoustic transducer diaphragm 1 by injection foaming.

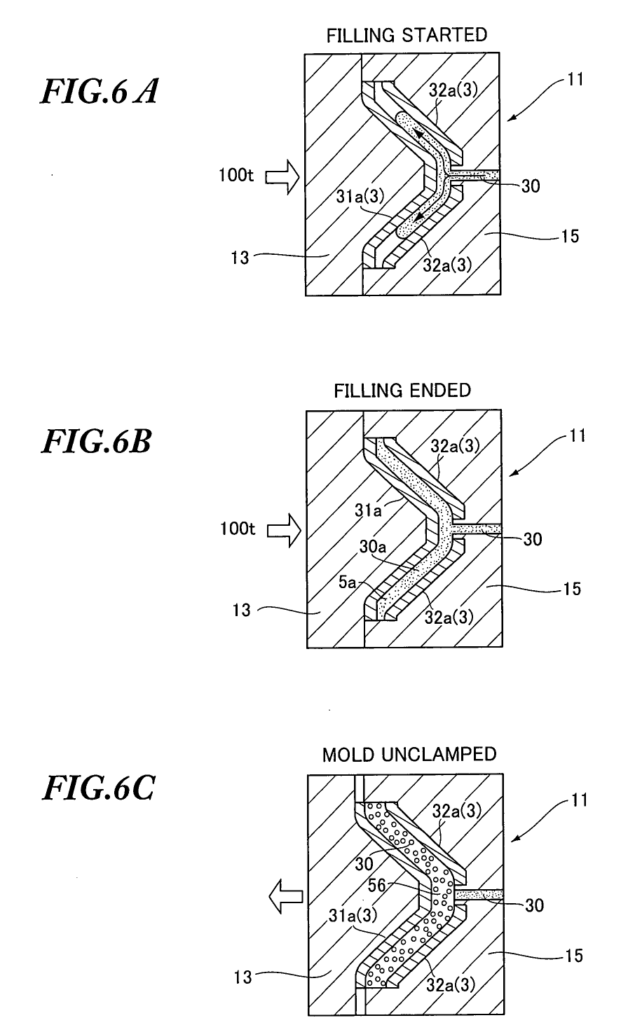

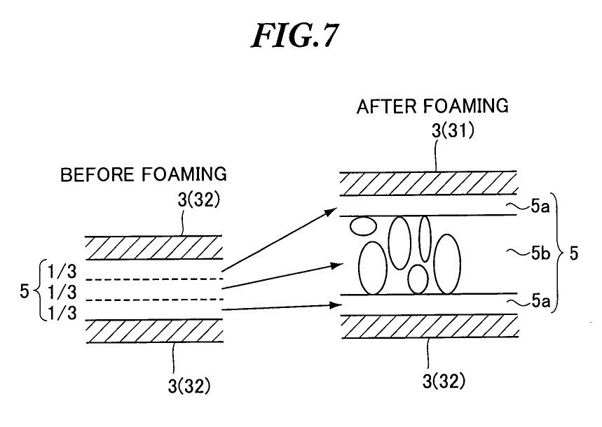

FIGS. 6A to 6C are explanatory views illustrating an injection foaming step in the method for manufacturing the electroacoustic transducer diaphragm 1. FIG. 7 is an explanatory sectional view illustrating the injection foaming step shown in FIGS. 6A to 6C.

The intermediate diaphragm layer 5 according to this embodiment is formed by injecting the injection material 30 containing a foaming agent into the injection mold 11 and then allowing it to foam therein. In more detail, as shown in FIG. 6A, after the separation between the male die 13 and the female die 15 of the injection mold 11 is set at a predetermined distance by a clamping mechanism of the injection molding machine 6, the injector 9 injects therebetween, for example, a resin mixture (injection material) 30 of PP (polypropylene) and the foaming agent with an inorganic or organic filler.

In this instance, the injection material 30 is kept at a specified temperature, for example, at approximately 230 degrees Celsius within the injector 9. The surface layers 31 and 32 are kept at a specified temperature, for example, at approximately 90 degrees Celsius. The mold clamping cylinder 8 is controlled by the mold clamping pressure control unit 7 to provide a clamping pressure kept at a specified pressure, for example, at approximately 100 t (ton). Furthermore, the typical thickness of the cavity defined by the male die 13 and the female die 15 of the injection mold 11 is set at a specified thickness, for example, at approximately 0.2 mm.

At this time, as shown in FIG. 6B, the injection material 30 filled in between the male die 13 and the female die 15 starts to solidify from the portion in contact with the injection mold 11 or the surface layers 31 and 32. As shown in FIG. 7, the solidified outer surface layers form skin layers 5a of the intermediate diaphragm layer 5. Since the molten portion is subjected to the pushing pressure from the screw portion of the injector 9 and the clamping pressure exerted by the male die 13 and the female die 15, the foaming agent decomposed into gases is compressed, thereby allowing the molten portion to continue to solidify while foaming is being suppressed.

Then, as shown in FIG. 6C, for example, immediately after the injection material 30 has been filled, the clamping pressure from the mold clamping cylinder 8 controlled by them old clamping pressure control unit 7 is instantaneously reduced to the vicinity of 0 t (ton) while the foaming pressure of the foaming agent in the molten portion is still high enough to spread the skin layers (solidified portions) 5a there around. This allows the compressed foaming agent decomposed into gases in the molten portion to expand and start to foam while spreading the resin there around, thereby forming a foaming layer 5b sandwiched between the skin layers 5a as shown in FIG. 7.

A description will now be given regarding the timing of unclamping the male die 13. If the mold is unclamped before the injection material 30 is completely filled, the resin mixture excessively goes into the cavity defined between the male die 13 and the female die 15 of the injection mold 11, thereby causing the product to be excessively increased in weight. Conversely, if the mold is unclamped too late, the resin excessively solidifies to such an extent that it completely solidifies without the foaming agent being allowed to foam. Accordingly, the timing of unclamping the mold should be determined so as not to raise these problems. Furthermore, for example, it is preferable to appropriately determine the timing of unclamping the mold depending on those conditions such as the resin temperature of the injection material 30, the temperature of the injection mold 11, the temperatures of the surface layers 31 and 32, the thickness of the product, and the amount of the foaming agent added.

As described above, the injection material 30 containing the foaming agent is injected into the injection mold 11 and foamed therein, thereby allowing the intermediate diaphragm layer 5 to have the non-foaming layers 5a formed in the skin layers and the foaming layer 5b formed in the core layer. The intermediate diaphragm layer 5 including the foaming layer 5b and the surface layers 31 and 32 are incorporated into the multi-layered electroacoustic transducer diaphragm 1. It is thus possible to provide the electroacoustic transducer diaphragm 1 which is reduced in weight and increased in rigidity.

Additionally, as described above, the intermediate diaphragm layer 5 formed by foaming has a comparatively high molding shrinkage. However, the electroacoustic transducer diaphragm 1 according to this embodiment is configured such that with the surface layers 31 and 32 having their fiber axial orientations shifted by a specified angle, the surface layer 31, the intermediate diaphragm layer 5, and the surface layer 32 are formed in one piece. Thus, the electroacoustic transducer diaphragm 1 is reduced in distortion and deformation.

Note that the present invention is not limited to the aforementioned embodiments. The aforementioned embodiments may be employed in combination. For example, the material for forming the surface layers 31 and 32 is not limited to the aforementioned ones.

Furthermore, for example, the electroacoustic transducer diaphragm 1 may also be formed of the surface layer 31 and the surface layer 32 which are made of a triaxial or more woven fabric.

Furthermore, the electroacoustic transducer diaphragm 1 has the three-layered structure comprising the surface layer 31, the intermediate diaphragm layer 5, and the surface layer 32 in the aforementioned embodiment; however, a multi-layered structure having four or more layers may also be employed.

As described above, the electroacoustic transducer diaphragm 1 according to the present invention is the multi-layered electroacoustic transducer diaphragm 1 which has the intermediate diaphragm layer 5 formed between the surface layer 31 and the surface layer 32. The surface layer 31 and the surface layer 32 are formed of a woven fabric, and have their fiber axial orientations shifted by a specified angle. Additionally, the surface layer 31 and the surface layer 32 are formed in one piece. It is thus possible to reduce the electroacoustic transducer diaphragm 1 in distortion and deformation. It is also possible to provide a high-quality multi-layered electroacoustic transducer diaphragm 1.

Preferably, the surface layers 31 and 32 made up of a biaxial woven fabric can be formed to have their fiber axial orientations shifted by approximately 45 degrees, thereby allowing further reduction in distortion.

Furthermore, the surface layer 31 made up of the biaxial woven fabric 31a and the surface layer 32 made up of the biaxial woven fabric 32a are inserted into the injection mold 11, with the woven fabric 32a having a fiber axial orientation shifted by a specified angle relative to the woven fabric 31a. Under this condition, the injection material 30 or a material for forming the intermediate diaphragm layer 5 is injected in between the surface layer 31 and the surface layer 32. In this manner, the surface layer 31, the intermediate diaphragm layer 5, and the surface layer 32 are formed in one piece by various manufacturing methods such as by insert molding. It is thus possible to readily provide an electroacoustic transducer diaphragm 1 which incorporates the functions of the present invention.

Furthermore, even when the intermediate diaphragm layer 5 is formed by foaming, it is possible to provide a high-quality electroacoustic transducer diaphragm 1 which has comparatively little distortion or small deformation.

Furthermore, even when the intermediate diaphragm layer 5 is formed of a material containing an olefin-based resin, it is possible to provide a high-quality electroacoustic transducer diaphragm 1 which has comparatively little distortion or small deformation.

While there has been described what are at present considered to be preferred embodiments of the present invention, it will be understood that various modifications may be made thereto, and it is intended that the appended claims cover all such modifications as fall within the true spirit and scope of the invention.

What is claimed is:

1. A multi-layered electroacoustic transducer diaphragm comprising: a first surface diaphragm layer; a second surface diaphragm layer; and an intermediate diaphragm layer formed between the first surface diaphragm layer and the second surface diaphragm layer,
wherein the first surface diaphragm layer and the second surface diaphragm layer are formed of a woven fabric, and
wherein the first surface diaphragm layer and the second surface diaphragm layer are formed in one piece with the first surface diaphragm layer and the second surface diaphragm layer having respective fiber axial orientations shifted by a specified angle.

2. The electroacoustic transducer diaphragm according to claim 1, wherein
with the first surface diaphragm layer and the second surface diaphragm layer being inserted in an injection mold, the first surface diaphragm layer being formed of a first biaxial woven fabric, the second surface diaphragm layer being formed of a second biaxial woven fabric having the fiber axial orientation shifted by the specified angle relative to the first woven fabric, an injection material serving as a material for forming the intermediate diaphragm layer is injected in between the first surface diaphragm layer and the second surface diaphragm layer, so that the first surface diaphragm layer, the intermediate diaphragm layer, and the second surface diaphragm layer are formed in one piece.

3. The electroacoustic transducer diaphragm according to claim 1, wherein the fiber axial orientations of the first surface diaphragm layer and the second surface diaphragm layer are shifted by approximately 45 degrees.

4. The electroacoustic transducer diaphragm according to claim 2, wherein the intermediate diaphragm layer is formed by foaming.

5. The electroacoustic transducer diaphragm according to claim 2, wherein the intermediate diaphragm layer is formed of a material containing an olefin-based resin.
